(19) United States
(12) Patent Application Publication
(10) Pub. No.: US 2015/0300427 A1
(43) Pub. Date: Oct. 22, 2015

(54) ELECTROMAGNETIC CLUTCH, ELECTROMAGNETIC CLUTCH CONTROL DEVICE, AND ELECTROMAGNETIC CLUTCH CONTROL METHOD

(71) Applicant: DENSO CORPORATION, Kariya-city, Aichi (JP)

(72) Inventors: Motohiko UEDA, Okazaki-city (JP); Tooru OOKUMA, Kariya-city (JP)

(21) Appl. No.: 14/441,438

(22) PCT Filed: Sep. 25, 2013
(86) PCT No.: PCT/JP2013/005669

§ 371 Date: May 7, 2015

(30) Foreign Application Priority Data
Nov. 8, 2012 (JP) 2012-246086

(51) Int. Cl. F16D 48/06; F16D 27/112

(52) U.S. Cl. CPC F16D 48/064; F16D 27/112

(57) ABSTRACT

An electromagnetic clutch provided with an armature in which two or more non-magnetic sections of differing radii are provided and which is installed on a rotary shaft, a rotor in which three or more non-magnetic section of differing radii that do not overlap with the non-magnetic sections are provided on a friction plate that faces the armature, and which rotates with respect to the rotation shaft by external force, a stator equipped with an electromagnetic coil for fixing the armature to the rotor by applying magnetic flux, which is generated by passage of an electric current, on the friction plate, and a control device for the electromagnetic coil. The control device is provided with a magnetomotive force change circuit for increasing, with a command to start power supply to the electromagnetic coil, the magnetomotive force of the electromagnetic coil above the magnetomotive force of the electromagnetic clutch during normal operation and for returning the magnetomotive force of the electromagnetic coil to the magnetomotive force of the electromagnetic clutch during normal operation when the armature is fixed to the rotor.

### CROSS-REFERENCE TO RELATED APPLICATION

The present application is based on Japanese patent application No. 2012-246086 filed on Nov. 8, 2012, the content of which is incorporated herein by reference.

### TECHNICAL FIELD

The present disclosure relates to an electromagnetic clutch, an electromagnetic clutch control device, and an electromagnetic clutch control method for intermittently transmitting power using an electromagnet.

### BACKGROUND ART

In a drive mechanism of a compressor for a vehicle air conditioner and the like, an electromagnetic clutch is used when power is intermittently transmitted using an electromagnetic coil. An armature is fixed to a distal end portion of a rotary shaft of the compressor. A rotor driven by an engine or the like is attached to the rotary shaft adjacent to the armature via a bearing, and is rotatable with respect to the rotary shaft. The rotor has a recess formed in a ring shape extending from the compressor side, and a stator including the electromagnetic coil is inserted into the recess while leaving a gap between itself and an inner wall of the recess. The armature is movable toward the rotor. When power is supplied to the electromagnetic coil, a magnetic flux passing through between the rotor and the armature causes the armature to be attracted to the rotor and to be fixedly attached to the rotor. A contact surface between the rotor and the armature has a friction plate disposed thereon. If the armature is fixedly attached to the rotor, rotation of the rotor is transmitted to the rotary shaft of the compressor via the armature, thereby rotating the compressor.

In general, the armature is divided into an inner armature and an outer armature by a slit disposed in a circumferential direction. The inner armature and the outer armature are connected to each other by a connection portion (bridge) which splits the slit into multiple portions in the circumferential direction. On the other hand, the rotor which is magnetically coupled to the armature has two slits provided in the circumferential direction so as not to overlap the slit of the armature. The rotor is split into an outer rotor, a central rotor, and an inner rotor by the two slits. The outer rotor and the central rotor, and the central rotor and the inner rotor are connected to each other by connection portions which split their respective slits into multiple portions in the circumferential direction. The electromagnetic clutch having the above-described configuration has four opposing surfaces between the rotor and the armature: a first opposing surface between the inner rotor and the inner armature, a second opposing surface between the inner armature and the central rotor, a third opposing surface between the central rotor and the outer armature, and a fourth opposing surface between the outer armature and the outer rotor.

Accordingly, when power is supplied to the electromagnetic coil, if a direction of a magnetic flux is from the inside to the outside of the rotor, the magnetic flux is blocked by a slit. Thus, the magnetic flux enters the inner armature from the inner rotor after passing through the first opposing surface. The magnetic flux entering the inner armature is similarly blocked by a slit. Thus, the magnetic flux passes through the second opposing surface, and enters the central rotor. Thereafter, the magnetic flux passes through the third opposing surface, enters the outer armature, and returns to the outer rotor after passing through the fourth opposing surface. As described above, the magnetic flux penetrates in a zigzag course between the rotor and the armature by using a route (magnetic path) starting from the inner rotor, to the inner armature, the central rotor, the outer armature, and to the outer rotor in this order. Accordingly, an attraction force between the rotor and the armature is strengthened.

Furthermore, an electromagnetic clutch with six opposing surfaces between the armature and the rotor is proposed by disposing two slits in the armature in the circumferential direction and by disposing three slits in the rotor in the circumferential direction so as not to overlap the slits of the armature (for example, refer to Patent Literature 1). The electromagnetic clutch having six opposing surfaces between the armature and the rotor requires only approximately two thirds of the magnetic flux in order to obtain the same transmission torque when power is supplied to the electromagnetic coil, as compared to the electromagnetic clutch having four opposing surfaces. Accordingly, power consumption can be minimized. If a required amount of magnetic flux is small, the thickness of an iron portion constituting a magnetic circuit of the electromagnetic coil can be made thinner, and the weight of the electromagnetic clutch can be decreased, thereby improving fuel efficiency for vehicles.

In an air gap between the rotor and the armature, the opposing surface having the magnetic path formed thereon is called an attraction surface or a magnetic pole. The electromagnetic clutch having four opposing surfaces is called a double flux electromagnetic clutch, and the electromagnetic clutch having six opposing surfaces is called a triple flux electromagnetic clutch. Hereinafter, the present disclosure will be described by referring to a portion (opposing surface) where the magnetic flux crosses the air gap between the rotor and the armature as an opposing magnetic path.

### PRIOR ART LITERATURE

### Patent Literature

Patent Literature 1: JP 2005-344876 A

### SUMMARY OF THE INVENTION

As described above, when six opposing magnetic paths are employed between the rotor and the armature, the electromagnetic clutch can generate a higher transmission torque as compared to when four opposing magnetic paths are employed. However, according to the study of the present inventor, if the number of opposing magnetic paths between the rotor and the armature is increased to six or more, the magnetic path crossing the air gap between the rotor and the armature is lengthened. Consequently, an electromagnetic attraction force when power is first supplied to the electromagnetic coil, that is, an actuation attraction force for switching the electromagnetic clutch from an off state to an on state becomes weaker, thereby causing a possibility of the operability (starting performance) of the electromagnetic clutch degrading.

The present disclosure is made in view of the above-described points, and aims to provide an electromagnetic clutch, an electromagnetic clutch control device, and an electromagnetic control method, where operability of the electromagnetic clutch is improved by improving the starting performance of the electromagnetic clutch while power consumption of the electromagnetic clutch is minimized.

An electromagnetic clutch according to a first example of the present disclosure includes an armature that is attached to a rotary shaft, at least two non-magnetic portions that are disposed in the armature, the at least two non-magnetic portions having varying radii in a circumferential direction, a rotor that is rotated with respect to the rotary shaft by an external force, a friction plate that faces the armature and is included in the rotor, at least three non-magnetic portions that are disposed in the friction plate and do not overlap the at least two non-magnetic portions, the at least three non-magnetic portions having varying radii in the circumferential direction, a stator, an electromagnetic coil that is included in the stator, the electromagnetic coil generating, when a power is supplied to the electromagnetic coil, a magnetic flux that is applied to the friction plate and causing the armature to be magnetically attracted to and fixedly attached to the rotor, a control device that controls supplying power to the electromagnetic coil, and a magnetomotive force change unit that is included in the control device, wherein when a command to start supplying power to the electromagnetic coil is issued, the magnetomotive force change unit increases a magnetomotive force of the electromagnetic coil, and when the armature is magnetically attracted to and fixedly attached to the rotor, the magnetomotive force change unit returns the magnetomotive force of the electromagnetic coil to a normal operation magnetomotive force.

An electromagnetic clutch control device according to a second example of the present disclosure is for an electromagnetic clutch, the electromagnetic clutch including an armature that is attached to a rotary shaft, at least two non-magnetic portions that are disposed in the armature, the at least two non-magnetic portions having varying radii in a circumferential direction, a rotor that is rotated with respect to the rotary shaft by an external force, a friction plate that faces the armature and is included in the rotor, at least three non-magnetic portions that are disposed in the friction plate and do not overlap the at least two non-magnetic portions, the at least three non-magnetic portions having varying radii in the circumferential direction, a stator, and an electromagnetic coil that is included in the stator, the electromagnetic coil generating, when a power is supplied to the electromagnetic coil, a magnetic flux that is applied to the friction plate and causing the armature to be magnetically attracted to and fixedly attached to the rotor, the electromagnetic clutch control device including a magnetomotive force change unit, wherein when a command to start supplying power to the electromagnetic coil is issued, the magnetomotive force change unit increases a magnetomotive force of the electromagnetic, and when the armature is magnetically attracted to and fixedly attached to, the magnetomotive force change unit returns the magnetomotive force of the electromagnetic coil to a normal operation magnetomotive force.

An electromagnetic clutch control method according to a third example of the present disclosure is for controlling an electromagnetic clutch, the electromagnetic clutch including an armature that is attached to a rotary shaft, at least two non-magnetic portions that are disposed in the armature, the at least two non-magnetic portion having varying radii in a circumferential direction, a rotor that is rotated with respect to the rotary shaft by an external force, a friction plate that faces the armature and is included in the rotor, at least three non-magnetic portions that are disposed in the friction plate and do not overlap the at least two non-magnetic portions, the at least three non-magnetic portions having varying radii in the circumferential direction, a stator, an electromagnetic coil that is included in the stator, the electromagnetic coil generating, when a power is supplied to the electromagnetic coil, a magnetic flux that is applied to the friction plate and causing the armature to be magnetically attracted to and fixedly attached to the rotor, and a control device that controls supplying power to the electromagnetic coil, the electromagnetic clutch control method including, when a command to start supplying power to the electromagnetic coil is issued, causing the control device to increase a magnetomotive force of the electromagnetic coil, and, when the armature is magnetically attracted to and fixedly attached to the rotor, causing the control device to return the magnetomotive force of the electromagnetic coil to a normal operation magnetomotive force.

According to the configuration, when the command to start power supply to the electromagnetic coil of the electromagnetic clutch is issued, a stronger magnetomotive force can be applied to the electromagnetic coil than that in normal operation. Accordingly, a strong electromagnetic attraction force is generated between the rotor and the armature. Thus, operability of the electromagnetic clutch can be improved when the electromagnetic clutch is switched from an off state to an on state. Thereafter, when the armature is magnetically attracted to and fixedly attached to the friction plate, the magnetomotive force of the electromagnetic coil returns to a normal state magnetomotive force. Therefore, power consumption of the electromagnetic coil can be minimized.

### BRIEF DESCRIPTION OF THE DRAWINGS

FIG. 1A is a configuration diagram illustrating an example of a configuration of a car air conditioning system when an electromagnetic clutch according to the present disclosure is installed in a compressor of a vehicle air conditioner (car air conditioner).

FIG. 1B is a partial configuration diagram illustrating a modified example where a control device illustrated in FIG. 1A is incorporated in an air conditioner computer (ECU).

FIG. 2A is a configuration diagram of an example of an electromagnetic clutch including a cross-sectional configuration of an electromagnetic clutch according to a first embodiment of the present disclosure attached to the compressor of the car air conditioning system illustrated in FIG. 1A.

FIG. 2B illustrates a configuration of a modified example of the embodiment described with reference to FIG. 2A, and is a partial configuration diagram illustrating an example where a PWM control circuit is used instead of a DC-DC converter.

FIG. 3 is a front view and a cross-sectional view which illustrate a rotor and an armature by comparing slit arrangements and connection portion positions with each other in the rotor having three slits and the armature having two slits.

FIG. 4(a) is a schematic cross-sectional view illustrating a state of the armature and the rotor when a friction surface air gap (air gap between opposing magnetic paths) is 0 mm (in an on state) in the electromagnetic clutch in which the armature has a single non-magnetic portion formed in a ring shape and a friction plate of the rotor has two non-magnetic portions formed in a ring shape. FIG. 4(b) is a schematic cross-sectional view illustrating a state of the armature and the rotor when the air gap between the opposing magnetic paths is 0.5 mm (when turned off) in the electromagnetic clutch illustrated in FIG. 4(a), FIG. 4(c) is a schematic cross-sectional view illustrating a state of the armature and the rotor when the air gap between the opposing magnetic paths is 0 mm (in an on state) in the electromagnetic clutch in which the armature has two non-magnetic portions formed in a ring shape and the friction plate of the rotor has three non-magnetic portions formed in a ring shape, and FIG. 4(d) is a schematic cross-sectional view illustrating a state of the armature and the rotor when the air gap between the opposing magnetic paths is 0.5 mm (when turned off) in the electromagnetic clutch illustrated in FIG. 4(a).

FIG. 5 is a table illustrating the number of opposing magnetic paths in the electromagnetic clutch illustrated in FIGS. 4(a) to 4(d) and comparison of a magnitude of an attraction force with that of a magnetomotive force of an electromagnetic coil in an on state and when an off state is switched to the on state.

FIG. 6A is a waveform diagram for illustrating an example of an operation of the DC-DC converter illustrated in FIG. 2A.

FIG. 6B is a waveform diagram for illustrating an example of an operation of the PWM control circuit illustrated in FIG. 2B.

FIG. 7A is a partial perspective view illustrating a structure of the rotor side when the non-magnetic portion disposed in the armature and the rotor of the electromagnetic clutch is configured to have a slit formed in a ring shape.

FIG. 7B is a partial perspective view illustrating a structure of the rotor side when the non-magnetic portion disposed in the armature and the rotor of the electromagnetic clutch is configured to have a ring-shaped member formed of a non-magnetic material.

FIG. 8 is a table illustrating comparison of the magnitude of the attraction force with that of the magnetomotive force of the electromagnetic coil in the on state and when the off state is switched to the on state in a case where the number of opposing magnetic paths between the armature and the rotor of the electromagnetic clutch is six and the non-magnetic portion disposed in the armature and the rotor is formed from a slit, and in a case where the non-magnetic portion is formed from a non-magnetic ring.

FIG. 9A is a configuration diagram of an example of an electromagnetic clutch including a cross-sectional configuration of an electromagnetic clutch, according to a second embodiment of the present disclosure, which is attached to the compressor of the car air conditioning system illustrated in FIG. 1A.

FIG. 9B illustrates a configuration of a modified example of the embodiment described with reference to FIG. 9A, and is a partial configuration diagram illustrating an example where the PWM control circuit is used instead of the DC-DC converter.

FIG. 10 is a front view and a cross-sectional view which illustrate the rotor, which has four slits, and the armature, which has three slits, by comparing slit arrangements and connection portion positions with each other.

### EMBODIMENTS FOR CARRYING OUT THE INVENTION

Hereinafter, embodiments of an electromagnetic clutch according to the present disclosure will be described based on specific examples with reference to the drawings. Here, as an example, an embodiment will be described where the electromagnetic clutch according to the present disclosure is attached to a vehicle auxiliary machine. In some cases, repeated description in each embodiment will be omitted by giving the same reference numerals to portions corresponding to elements described previously. When only a portion of configurations in each example is described, another embodiment described previously can be applied to the other portions of the configurations. Portions described as that a specific combination is possible in respective examples can be combined with each other. Moreover, if no problems particularly occur in the combination, the respective examples can also be partially combined with each other without being described.

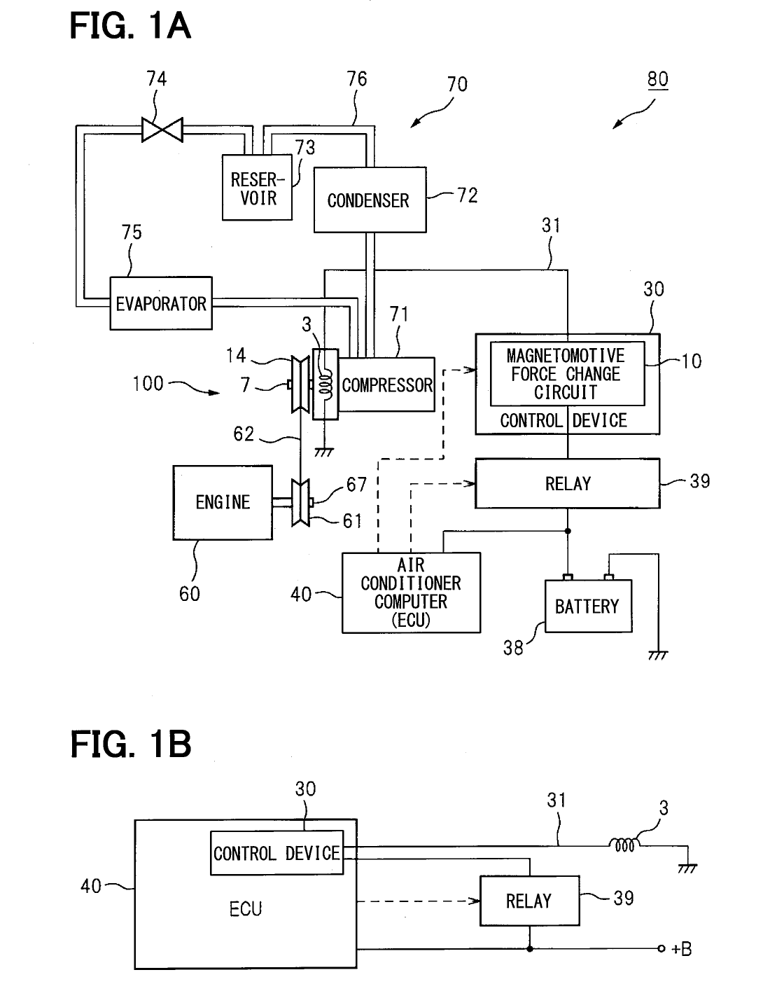

FIG. 1A illustrates an example of a configuration of a car air conditioning system 80 when an electromagnetic clutch 100 according to the present disclosure is installed in a compressor 71 of a vehicle air conditioner (car air conditioner) 70. The car air conditioner 70 keeps the air inside a vehicle compartment comfortable by cooling and dehumidifying the air, and includes the compressor 71, a condenser 72, a reservoir 73, an expansion valve 74, an evaporator 75, and a refrigerant passage 76 for connecting the above-described members to one another. A refrigerant filling the refrigerant passage 76 is compressed by the compressor 71 so as to become a high-temperature and high-pressure gas, is cooled by the condenser 72 so as to be liquefied, and then is temporarily stored in the reservoir 73. The refrigerant discharged from the reservoir 73 becomes a low-pressure and low-temperature mist in the expansion valve 74. The refrigerant is vaporized by the evaporator 75 so as to remove heat from the surroundings thereof and so as to become entirely gaseous, and returns to the compressor 71. The car air conditioner 70 adjusts a temperature inside the vehicle compartment in such a way that air inside the vehicle compartment or external air is cooled by being passed through the evaporator 75 and is blown into the vehicle compartment after temperature adjustment through a separately disposed heater core.

The compressor 71 is driven by an engine 60, and is driven by a belt 62 laid between a pulley 61 attached to a rotary shaft 67 of the engine 60 and a pulley 14 attached to a rotary shaft 7 of the compressor 71. The electromagnetic clutch 100 transmits or blocks the rotation of the pulley 14 to the rotary shaft 7 of the compressor 71. The electromagnetic clutch 100 transmits drive power of the engine 60 to the compressor 71 in an on state where power is supplied to an electromagnetic coil 3, and blocks the drive power of the engine 60 during an off state where power is not supplied to the electromagnetic coil 3.

The electromagnetic coil 3 is connected to a vehicle battery 38 through a control device 30 and a relay 39. If the relay 39 is turned on and a current value (magnetomotive force of the electromagnetic coil) is determined by the control device 30, a current from the battery 38 flows into the electromagnetic coil 3. The control device 30 has a magnetomotive force change circuit (magnetomotive force change unit) 10, and the magnetomotive force applied to the electromagnetic coil 3 can be changed by the magnetomotive force change circuit 10. An air conditioner computer (ECU) 40 which issues a command indicated by the dashed line to the relay 39 and the control device 30 can perform turning on and off of the relay 39, and can change the magnetomotive force by using the magnetomotive force change circuit 10. If the magnetomotive force change circuit 10 is disposed separately from the ECU 40, a vehicle side ECU will not need additional modifications. As is in a modified example illustrated in FIG. 1B, the control device 30 can be incorporated in the ECU 40. The reference number +B indicates a positive terminal (battery power source) of the battery 38 illustrated in FIG. 1A.

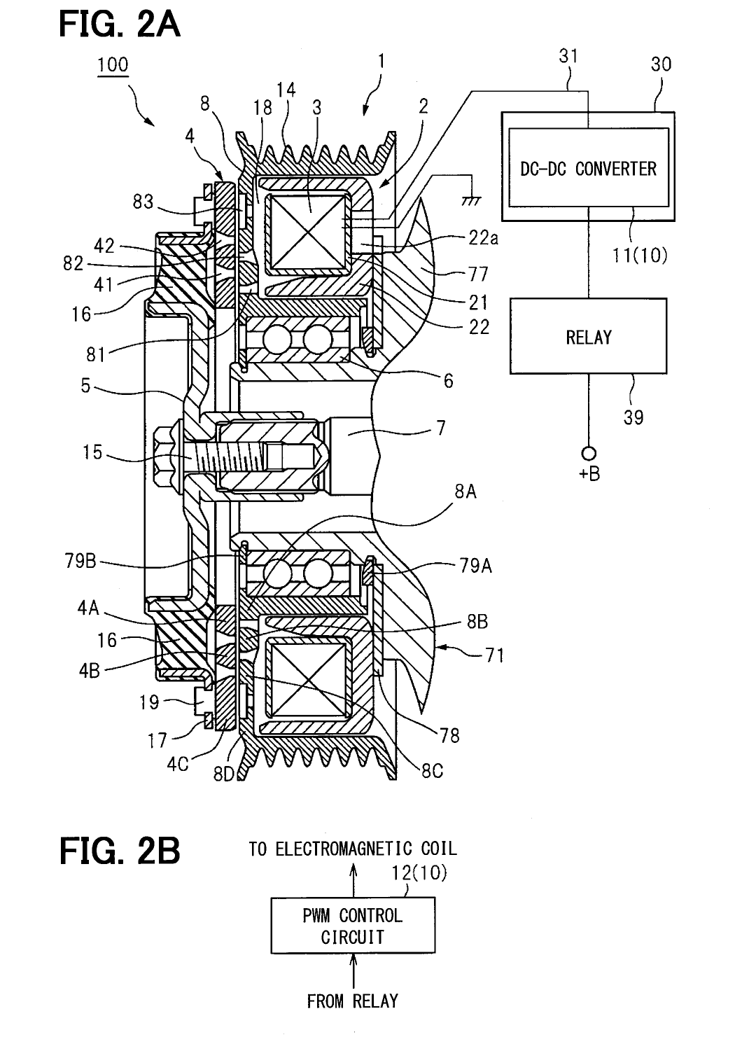

FIG. 2A illustrates an example of the electromagnetic clutch 100, including a cross-sectional configuration of the electromagnetic clutch 100 according to a first embodiment of the present disclosure, which is attached to the compressor 71 of the car air conditioning system 80 illustrated in FIG. 1A. A rotor 1 mainly composed of a magnetic material such as iron is rotatably fixed to a housing 77 of the compressor 71 via a bearing 6. The reference numeral 79B is a retaining ring for fixing the bearing 6 to the housing 77 of the compressor 71. On the other hand, an inner hub 5 is fixed to a distal end portion of the rotary shaft 7 of the compressor 71 by a bolt 15. An outer hub 17 is attached to an outer peripheral portion of the inner hub 5 via a damper rubber 16. An armature 4 mainly composed of a magnetic material is fixed to a surface on the rotor 1 side of the outer hub 17 by an attachment member 19. The inner hub 5, the damper rubber 16, the outer hub 17, and the armature 4 are rotated with the rotary shaft 7. In this case, the armature 4 is elastically held with respect to the inner hub 5 by the action of the damper rubber 16, and can move toward the rotor 1.

In the rotor 1, an end plate on the armature 4 side is a friction plate 8, and a friction surface on the surface of the friction plate 8 connects to and disconnects from the armature 4. The outer peripheral portion of the rotor 1 is the pulley 14 illustrated in FIG. 1A, and a V-projection of a belt (not illustrated) engages with multiple V-grooves disposed in the pulley 14. On the other hand, the rotor 1 has a recess 18 formed in a ring shape which opens to the housing 77 side of the compressor 71, and the rotor 1 has a U-shape in a cross section. A stator 2 fixed to the housing 77 of the compressor 71 is inserted into the recess 18. A gap is present between the stator 2 and an inner wall surface of the recess 18 of the rotor 1, and the rotor 1 can be rotated around the rotary shaft 7 without coming into contact with the stator 2.

The stator 2 includes the electromagnetic coil 3 wound inside a ring-shaped spool 21, a yoke portion 22 disposed around the spool 21, and an attachment plate 78 to which the yoke portion 22 is fixedly attached. The attachment plate 78 is fixed to the housing 77 of the compressor 71 by a retaining ring 79A. The spool 21 is formed by way of resin molding using a resin having electrical insulating properties as a constituting material. The yoke portion 22 of the stator 2 has a through-hole 22a, and both end portions of the electromagnetic coil 3 are drawn outward by a lead wire 31 through the through-hole 22a. One end of the lead wire 31 is electrically grounded to a vehicle side, and the other end of the lead wire 31 is connected to the battery power source +B through the control device 30 and the relay 39. In the present embodiment, a DC-DC converter (voltage change unit) 11 for boosting a voltage of the battery power source +B is incorporated into the control device 30 as the magnetomotive force change circuit 10. As the magnetomotive force change circuit 10 provided for the electromagnetic coil 3, a PWM control circuit (duty ratio change unit) 12 illustrated in FIG. 2B can also be used instead of the DC-DC converter 11.

Furthermore, the friction plate 8 on the armature 4 side of the rotor 1 according to the present disclosure has three or more ring-shaped slits having radii different from each other and serving as a non-magnetic portion which is a magnetism blocking portion. The slits interlink magnetic flux, which is generated by the electromagnetic coil 3 incorporated in the stator 2, with the armature 4. Three ring-shaped slits 81, 82, and 83 having different radii from one another are disposed sequentially from the bearing 6 side in the friction plate 8 according to the present embodiment. The slits 81, 82, and 83 split the friction plate 8 into a first rotor portion 8A, a second rotor portion 8B, a third rotor portion 8C, and a fourth rotor portion 8D sequentially from the rotary shaft 7 side. If the slits 81, 82, and 83 are air gaps, a connection portion is disposed in each of the slits 81, 82, and 83 in order to connect the first rotor portion 8A and the second rotor portion 8B to each other, the second rotor portion 8B and the third rotor portion 8C to each other, and the third rotor portion 8C and the fourth rotor portion 8D to each other. The connection portion will be described later. In additional, when the air gaps of the slits 81, 82, and 83 are filled with a non-magnetic material such as copper and stainless steel to form non-magnetic rings, the connection portions are not required.

Similarly, the armature 4 which faces the friction plate 8 and is a plate-like annular member also has two or more ring-shaped slits serving as a non-magnetic portion which is a magnetism blocking portion, in order to interlink the magnetic flux with the friction plate 8. The radii of the slits disposed in the armature 4 are different from the radii of the slits disposed in the friction plate 8. Two ring-shaped slits 41 and 42 having radii different from each other are disposed sequentially from the rotary shaft 7 side in the armature 4 according to the present embodiment. The slits 41 and 42 split the armature 4 into a first ring portion 4A, a second ring portion 4B, and a third ring portion 4C sequentially from the rotary shaft 7 side. If the slits 41 and 42 are air gaps, a connection portion is disposed in each of the slits 41 and 42 in order to connect the first ring portion 4A and the second ring portion 4B to each other, and the second ring portion 4B and the third ring portion 4C to each other. The connection portion will be described later. In additional, when the air gaps of the slits 41 and 42 are filled with a non-magnetic material such as copper and stainless steel to form non-magnetic rings, the connection portions are not required.

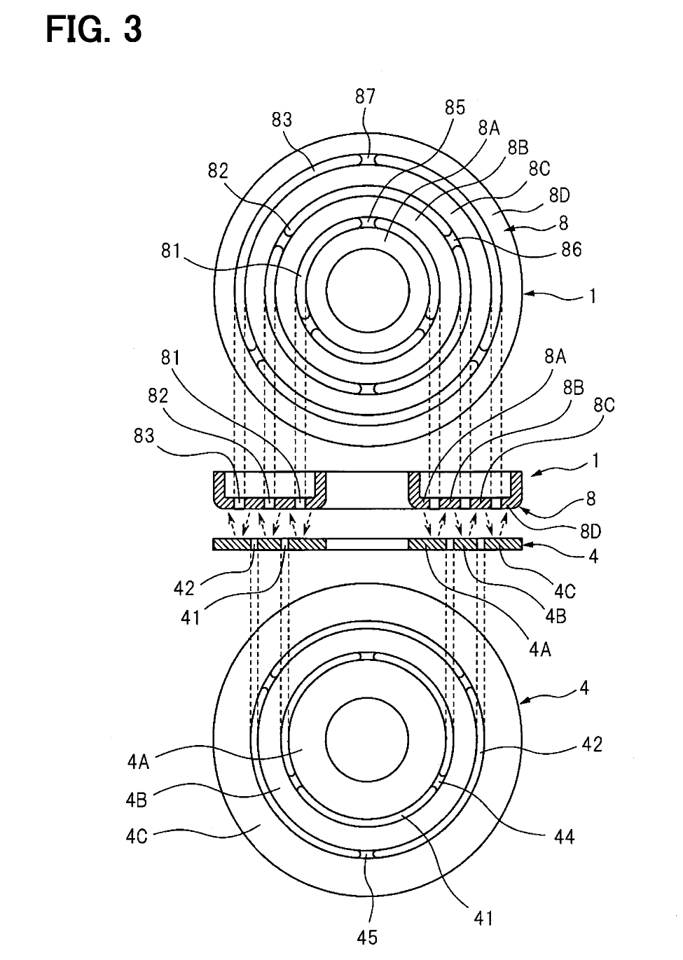

FIG. 3 illustrates a schematic configuration of a rotor 1 having three slits 81, 82, and 83, and the armature 4 having two slits 41 and 42 which are used in the present disclosure. FIG. 3 is provided to illustrate a relationship of the slits 41 and 42, and the slits 81, 82, and 83 with the connection portions. As illustrated in FIG. 3, when three slits 81, 82, and 83 are disposed in the rotor 1, connection portions 85, 86, and 87 are disposed at three locations in each of the slits 81, 82, and 83. In the example, the connection portions 85, 86, and 87 are disposed at every 120 degrees around the rotor 1. However, the number and the position of the connection portions 85, 86, and 87 are not limited to the example. The slits 81, 82, and 83 split the friction plate 8 into the first rotor portion 8A, the second rotor portion 8B, the third rotor portion 8C, and the fourth rotor portion 8D sequentially from the inner side.

When three slits 81, 82, and 83 are disposed in the rotor 1, the slits 41 and 42 in the opposing armature 4 are respectively disposed in portions opposing the second rotor portion 8B and the third rotor portion 8C. Accordingly, the radii of the slits 41 and 42 have different values from the radii of the slits 81, 82, and 83. When two slits 41 and 42 are disposed in the armature 4, connection portions 44 and 45 are disposed at three locations in each of the slits 41 and 42. In the example, the connection portions 44 and 45 are disposed at every 120 degrees around the armature 4. However, the number and the position of the connection portions 44 and 45 are not limited to the example. The slits 41 and 42 split the armature 4 into the first ring portion 4A, the second ring portion 4B, and the third ring portion 4C sequentially from the inner side.

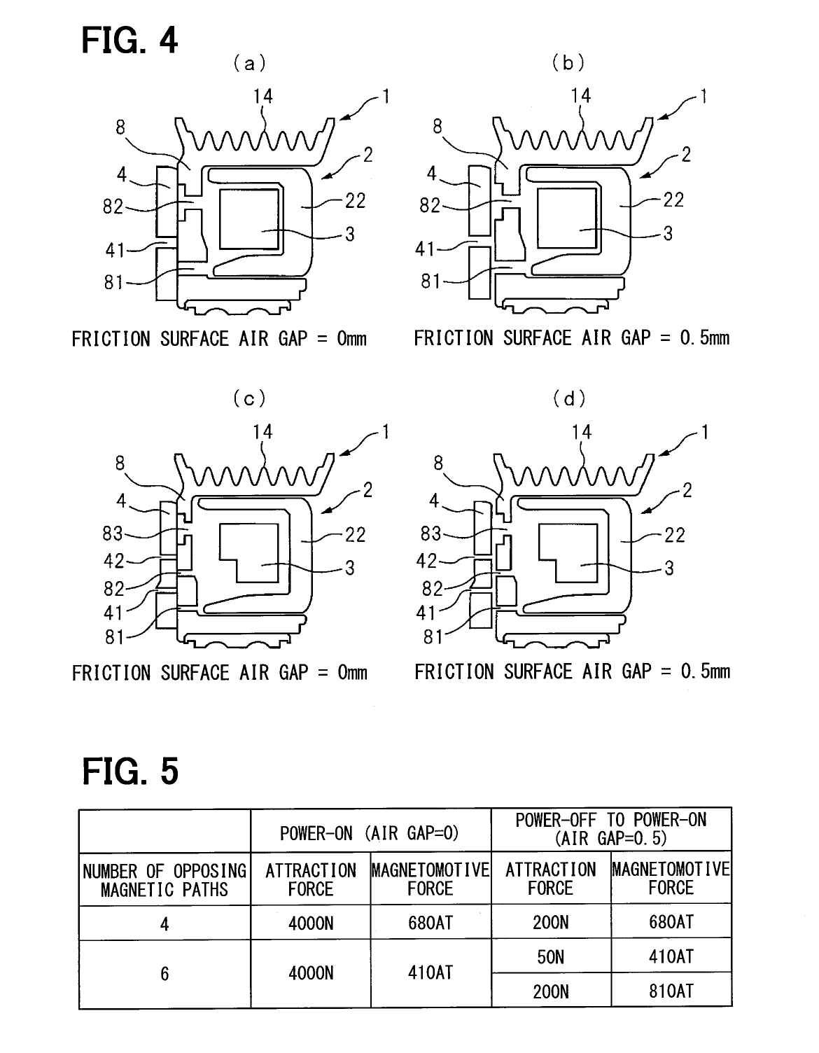

In the rotor 1 and the armature 4 which are configured as described above, the first ring portion 4A opposes the first rotor portion 8A and the second rotor portion 8B, the second ring portion 4B opposes the second rotor portion 8B and the third rotor portion 8C, and the third ring portion 4C opposes the third rotor portion 8C and the fourth rotor portion 8D. In this manner, a set of opposing surfaces through which the magnetic flux passes, that is, six opposing magnetic paths are present between the armature 4 and the friction plate 8 of the rotor 1. In the configuration, the magnetic flux flowing out from the first rotor portion 8A is interlinked with six opposing magnetic paths in a route sequentially from the first ring portion 4A, to the second rotor portion 8B, the second ring portion 4B, the third rotor portion 8C, the third ring portion 4C, and to the fourth rotor portion 8D as illustrated by the dashed line in FIG. 3. If six opposing magnetic paths are provided between the rotor 1 and the armature 4, a stronger attraction force is generated between the rotor 1 and the armature 4 as compared to a case where only four opposing magnetic paths are provided. In other words, if six opposing magnetic paths are provided in a case of the same attraction force, the magnetomotive force applied to the electromagnetic coil can be further decreased as compared to the case where only four opposing magnetic paths are provided. The reason will be described with reference to FIGS. 4 and 5.

FIG. 4(a) is a schematic cross-sectional view illustrating the armature and the rotor when a friction surface air gap (air gap between opposing magnetic paths) is 0 mm (in an on state) in the electromagnetic clutch in which the armature 4 has a single ring-shaped non-magnetic portion 41 and the friction plate 8 of the rotor 1 has two ring-shaped non-magnetic portions 81 and 82. FIG. 4(b) is a schematic cross-sectional view illustrating the armature 4 and the rotor 1 when the air gap between the opposing magnetic paths is 0.5 mm (when turned off) in the electromagnetic clutch illustrated in FIG. 4(a). FIG. 4(c) is a schematic cross-sectional view illustrating the armature 4 and the rotor 1 when the air gap between the opposing magnetic paths is 0 mm (in an on state) in the electromagnetic clutch in which the armature 4 has two ring-shaped non-magnetic portions 41 and 42, and the friction plate 8 of the rotor 1 has three ring-shaped non-magnetic portions 81, 82, and 83. FIG. 4(d) is a schematic cross-sectional view illustrating the armature 4 and the rotor 1 when the air gap between the opposing magnetic paths is 0.5 mm (when turned off) in the electromagnetic clutch illustrated in FIG. 4(a). Members having the reference numerals illustrated in FIGS. 4(a) to 4(d) correspond to members having the reference numerals described with reference to FIG. 2.

FIG. 5 is a table illustrating the number of opposing magnetic paths in the electromagnetic clutch illustrated in FIGS. 4(a) to 4(d) and a comparison of a magnitude of the attraction force with that of the magnetomotive force of the electromagnetic coil in an on state and when an off state is switched to the on state. The magnetomotive force is a current for obtaining a required attraction force. As is understood from FIG. 5, when the number of opposing magnetic paths is four, the magnetomotive force for obtaining an attraction force of 4000 N in the on state is 680 AT, and the magnetomotive force for obtaining an attraction force of 200 N when the off state is switched to the on state is 680 AT. In contrast, when the number of opposing magnetic paths is six, the magnetomotive force for obtaining an attraction force of 4000 N in the on state may be 410 AT. Accordingly, the magnetomotive force when the electromagnetic clutch is held in an on state is reduced when the number of opposing magnetic paths is six.

Next, with regard to the attraction force and the magnetomotive force when the electromagnetic clutch is switched from the off state to the on state, the magnetomotive force for obtaining the attraction force of 200 N when the number of opposing magnetic paths is six and the off state is switched to the on state is 810 AT. If the off state is switched to the on state by using the magnetomotive force of 410 AT in the on state, only an attraction force of 50 N can be obtained. In contrast, the attraction force of 200 N can be obtained if the number of opposing magnetic paths is four and the off state is switched to the on state by using the magnetomotive force of 680 AT in the on state. It is understood that when the off state is switched to the on state, the attraction force is weaker in a case where the number of opposing magnetic paths is six than that in a case where the number of opposing magnetic paths is four. Consequently, in a case of the electromagnetic clutch in which the number of opposing magnetic paths is six, an actuation attraction force for switching the electromagnetic clutch from the off state to the on state is decreased when the electromagnetic coil is driven using the magnetomotive force used in the on state, thereby causing a possibility of the operability (starting performance) of the electromagnetic clutch degrading.

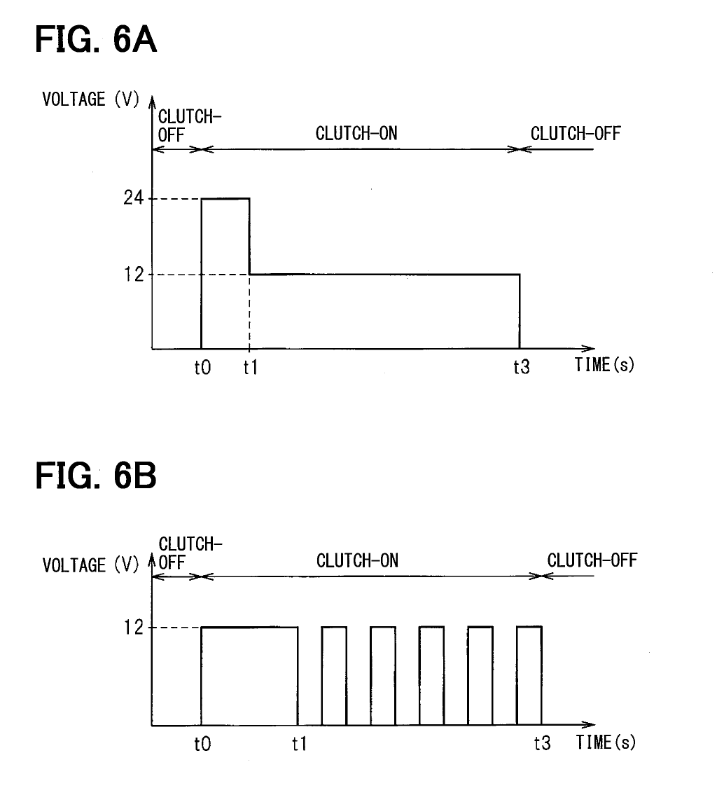

Therefore, according to the present disclosure, the DC-DC converter 11 illustrated in FIG. 2A increases the magnetomotive force of the electromagnetic coil when the electromagnetic clutch is turned on, by increasing a voltage applied to the electromagnetic coil. FIG. 6A is a waveform diagram for illustrating an example of an operation of the DC-DC converter 11 illustrated in FIG. 2A. In the example, if the electromagnetic clutch is turned on at a time t0 in a state where the electromagnetic clutch is turned off, the DC-DC converter 11 raises a battery voltage of 12 V to 24 V, for example, and the raised battery voltage is applied to the electromagnetic coil. At a time t1 when the armature of the electromagnetic clutch is attracted to the rotor and the air gap becomes zero, the DC-DC converter 11 returns the voltage applied to the electromagnetic coil to the battery voltage of 12 V. The time t1 when the armature of the electromagnetic clutch is attracted to the rotor and the air gap becomes zero can be detected by disposing a sensor in the electromagnetic clutch. However, in general, the time t1 can be determined by setting a predetermined elapsed time from the detection of a signal for turning on the electromagnetic clutch. The time when the armature of the electromagnetic clutch is attracted to the rotor and the air gap becomes zero varies depending on machine types. However, the time is between 0.1 to 1 second, and may be determined according to machine types.

For example, when the number of windings of the electromagnetic coil is 203 turns (T) and the electromagnetic coil has a resistance value of 6Ω, in a normal on state of the electromagnetic clutch, a power supply voltage is 12 V and a current of 2 A flows in the electromagnetic coil. Accordingly, the magnetomotive force of the electromagnetic coil is expressed by 2 A×203 T=406 AT. On the other hand, when the electromagnetic coil is switched from the off state to the on state, the power supply voltage is set to 24 V. Accordingly, a current of 4 A flows in the electromagnetic coil, and the magnetomotive force of the electromagnetic coil is expressed by 4 A×203 T=812 AT. As a result, when the number of opposing magnetic paths is six, similarly to a case illustrated in FIG. 5 where the number of opposing magnetic paths is four, it is also possible to obtain the attraction force which is the same as the attraction force of 4000 N required in the turned on state of the electromagnetic clutch and the attraction force of 200 N required when the off state is switched to the on state.

Next, control when using the PWM control circuit 12 illustrated in FIG. 2B will be described. The PWM control circuit 12 can change the magnetomotive force applied to the electromagnetic coil by intermittently applying a power supply voltage of 12 V to the electromagnetic coil and by changing a duty ratio of a voltage applied to the electromagnetic coil. FIG. 6B is a waveform diagram for illustrating an example of an operation of the PWM control circuit 12 illustrated in FIG. 2B. In the example, if the electromagnetic clutch is turned on at a time t0 in a state where the electromagnetic clutch is turned off, the duty ratio of the voltage applied to the electromagnetic coil is controlled to be 100% by the PWM control circuit 12. At a time t1 when the armature of the electromagnetic clutch is attracted to the rotor and the air gap is zero, the duty ratio of the voltage applied to the electromagnetic coil is lowered by the PWM control circuit 12.

For example, in a case where the winding number of the electromagnetic coil is 203 turns (T) and the electromagnetic coil has a resistance value of 3Ω, when the electromagnetic coil is switched from the off state to the on state, the power supply voltage is 12 V and the duty ratio is 100%. In this case, a current of 4 A flows in the electromagnetic coil and thus, the magnetomotive force of the electromagnetic coil is expressed by 4 A×203 T=812 AT. On the other hand, when the electromagnetic coil is in a normal on state, the current of 2.3 A is caused to flow in the electromagnetic coil by lowering the duty ratio. In this case, since a current of 2.3 A flows in the electromagnetic coil, the magnetomotive force of the electromagnetic coil is expressed by 2.3 A×203 T=412.09 AT. As a result, when the number of opposing magnetic paths is six, similarly to a case illustrated in FIG. 5 where the number of opposing magnetic paths is four, it is also possible to obtain the attraction force which is the same as the attraction force of 4000 N required in the turned on state of the electromagnetic clutch and the attraction force of 200 N required when the off state is switched to the on state.

In a case where the winding number of the electromagnetic coil is 203 turns (T) and the electromagnetic coil has a resistance value of 3Ω, if the DC-DC converter 11 illustrated in FIG. 2A is used, a voltage of 6 V may be applied to the electromagnetic coil when the electromagnetic clutch is turned on, and the voltage of 12 V may be applied to the electromagnetic coil when the turned off state is switched to the on state.

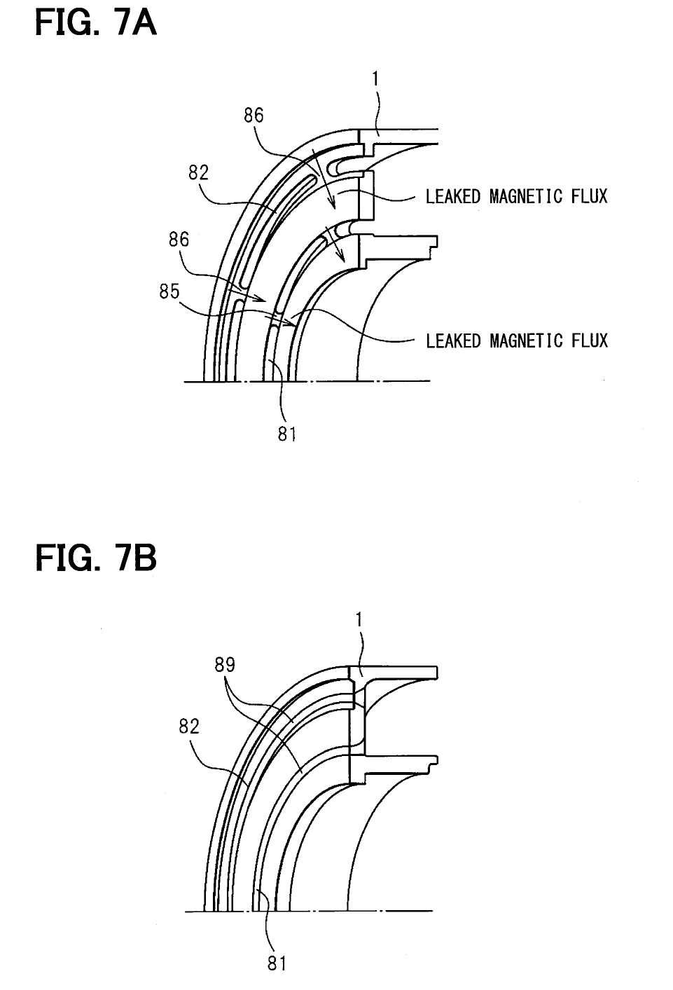

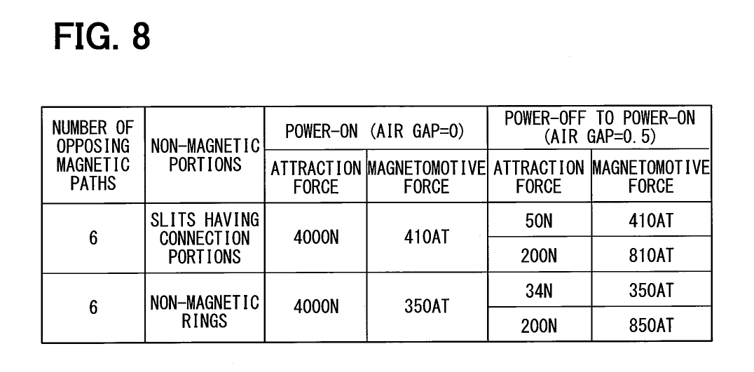

Here, magnetic efficiency when the connection portion is disposed in the slits disposed in the rotor 1 and when the non-magnetic rings made of a resin are embedded in the slits will be described. FIG. 7A illustrates a structure of the ring-shaped slits, and FIG. 7B illustrates a structure of the non-magnetic rings made of a non-magnetic material such as copper and stainless steel which fills the slits. To simplify the explanation, FIG. 7A and (b) illustrate cases where two slits are disposed in the rotor, but FIG. 8 illustrates numerical values when the number of opposing magnetic paths between the armature and the rotor of the electromagnetic clutch is six. As illustrated in FIG. 7A, the connection portions 85 and 86 are bridges which are made of the same material as the rotor 1, which divide the ring-shaped slits 81 and 82 serving as the non-magnetic portions disposed in the rotor 1 of the electromagnetic clutch. As illustrated in FIG. 7B, the non-magnetic rings 89 are rings made of a non-magnetic material such as copper and stainless steel, which fill the ring-shaped slits 81 and 82 disposed in the rotor 1 of the electromagnetic clutch. The non-magnetic rings 89 are members for connecting both sides of the ring-shaped slits 81 and 82 to each other. The table illustrated in FIG. 8 shows, when the number of opposing magnetic paths is six between the armature and the rotor of the electromagnetic clutch, a magnitude of the attraction force with respect to the magnetomotive force of the electromagnetic coil in the on state and when the off state is switched to the on state, in a case where the non-magnetic portion is formed from the slits and in a case where the non-magnetic portion is configured to have the non-magnetic rings.

As is understood from FIG. 8, even in a case where the number of opposing magnetic paths is six, when the electromagnetic clutch is on, the magnetomotive force applied to the electromagnetic coil in order to obtain the same attraction force is reduced when the slits are filled with the non-magnetic rings as compared to when the ring-shaped slits of the rotor are air gaps. Incidentally, when the electromagnetic clutch is switched from the off state to the on state, if the same magnetomotive force used in the on state is applied to the electromagnetic coil, the attraction force is 50 N in a case where the ring-shaped slits are air gaps. When the ring-shaped slits are filled with the non-magnetic rings, the attraction force is as weak as 34 N. In order to obtain the attraction force of 200 N required when the electromagnetic clutch is switched from the off state to the on state, a magnetomotive force of 810 AT is required in a case where the ring-shaped slits are air gaps, and a magnetomotive force of 850 AT is required in a case where the ring-shaped slits are filled with the non-magnetic rings.

However, if the control is performed by using the DC-DC converter 11 according to the present disclosure illustrated in FIG. 2 or the PWM control circuit 12, even in a case where the number of opposing magnetic paths is six, the electromagnetic clutch having the slits filled with the non-magnetic rings can be practically used without needing the ring-shaped slits disposed in the rotor to be air gaps. The electromagnetic clutch 100 including the DC-DC converter 11 according to the present disclosure illustrated in FIG. 2 or the PWM control circuit 12 can perform the control even if the number of opposing magnetic paths is more than six.

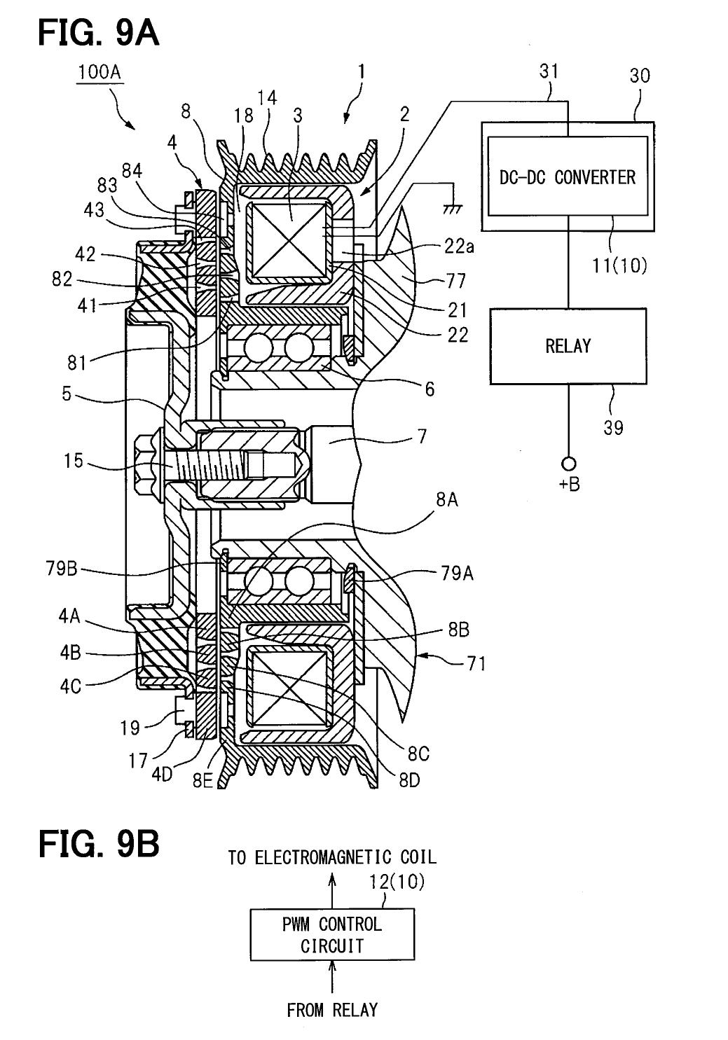

Therefore, an electromagnetic clutch 100A according to a second embodiment of the present disclosure in which the number of opposing magnetic paths is eight will be described with reference to FIG. 9. FIG. 9A is a configuration diagram of an example of the electromagnetic clutch 100A including a cross-sectional configuration of the electromagnetic clutch 100A according to the second embodiment of the present disclosure, which is attached to the compressor of the car air conditioning system illustrated in FIG. 1A. A point of difference between the electromagnetic clutch 100A according to the second embodiment and the electromagnetic clutch 100 according to the first embodiment is only the structures of the friction plate 8 of the rotor 1 and the armature 4. The other structures are completely the same as those in the electromagnetic clutch 100 according to the first embodiment. Accordingly, in the electromagnetic clutch 100A of the second embodiment, the same reference numerals as those in the electromagnetic clutch 100 according to the first embodiment are given to constitution members other than the friction plate 8 and the armature 4, and descriptions thereof will be omitted.

In order to interlink magnetic flux generated by the electromagnetic coil 3 incorporated in the stator 2 with the friction plate 8 to the armature 4, the electromagnetic clutch 100 according to the first embodiment has three ring-shaped slits 81, 82, and 83 having radii different from each other, disposed sequentially from the bearing 6 side. The slits 81, 82, and 83 split the friction plate 8 into the first rotor portion 8A, the second rotor portion 8B, the third rotor portion 8C, and the fourth rotor portion 8D sequentially from the rotary shaft 7 side. In contrast, in the electromagnetic clutch 100A according to the second embodiment, the friction plate 8 has four ring-shaped slits 81, 82, 83, and 84 having radii different from one another, disposed sequentially from the bearing 6 side. The slits 81, 82, 83, and 84 split the friction plate 8 into the first rotor portion 8A, the second rotor portion 8B, the third rotor portion 8C, the fourth rotor portion 8D, and a fifth rotor portion 8E sequentially from the rotary shaft 7 side.

The first embodiment is the same as the second embodiment in that if the slits 81, 82, 83, and 84 are air gaps, the connection portions are disposed in each of the slits 81, 82, 83, and 84 in order to connect the first rotor portion 8A and the second rotor portion 8B to each other, the second rotor portion 8B and the third rotor portion 8C to each other, the third rotor portion 8C and the fourth rotor portion 8D to each other, and the fourth rotor portion 8D and the fifth rotor portion 8E to each other. When the non-magnetic rings are formed by filling the air gaps of the slits 81, 82, 83, and 84 with a member of a non-magnetic material such as copper and stainless steel, the connection portions are not required.

On the other hand, the armature 4 according to the first embodiment has two ring-shaped slits 41 and 42 having radii different from each other, disposed sequentially from the rotary shaft 7 side. The slits 41 and 42 split the armature 4 into the first ring portion 4A, the second ring portion 4B, and the third ring portion 4C sequentially from the rotary shaft 7 side. In contrast, in the electromagnetic clutch 100A according to the second embodiment, the armature 4 has three ring-shaped slits 41, 42, and 43 having radii different from one another, disposed sequentially from the rotary shaft 7 side. The slits 41, 42, and 43 split the armature 4 into the first ring portion 4A, the second ring portion 4B, the third ring portion 4C, and a fourth ring portion 4D from the rotary shaft 7 side. When the slits 41, 42, and 43 are air gaps, the connection portions are disposed in each of the slits 41, 42, and 43 in order to connect the first ring portion 4A and the second ring portion 4B to each other, the second ring portion 4B and the third ring portion 4C to each other, and the third ring portion 4C and the fourth ring portion 4D to each other. When the non-magnetic rings are formed by filling the air gaps of the slits 41, 42, and 43 with a member of a non-magnetic material such as copper and stainless steel, the connection portions are not required.

FIG. 9B illustrates a configuration of a modified example of the example of the electromagnetic clutch 100A according to the second embodiment, which is described with reference to FIG. 9A, and is a partial configuration diagram illustrating an example where the PWM control circuit 12 is used instead of the DC-DC converter 11. The electromagnetic clutch 100A according to the second embodiment can also employ either the DC-DC converter 11 or the PWM control circuit 12.

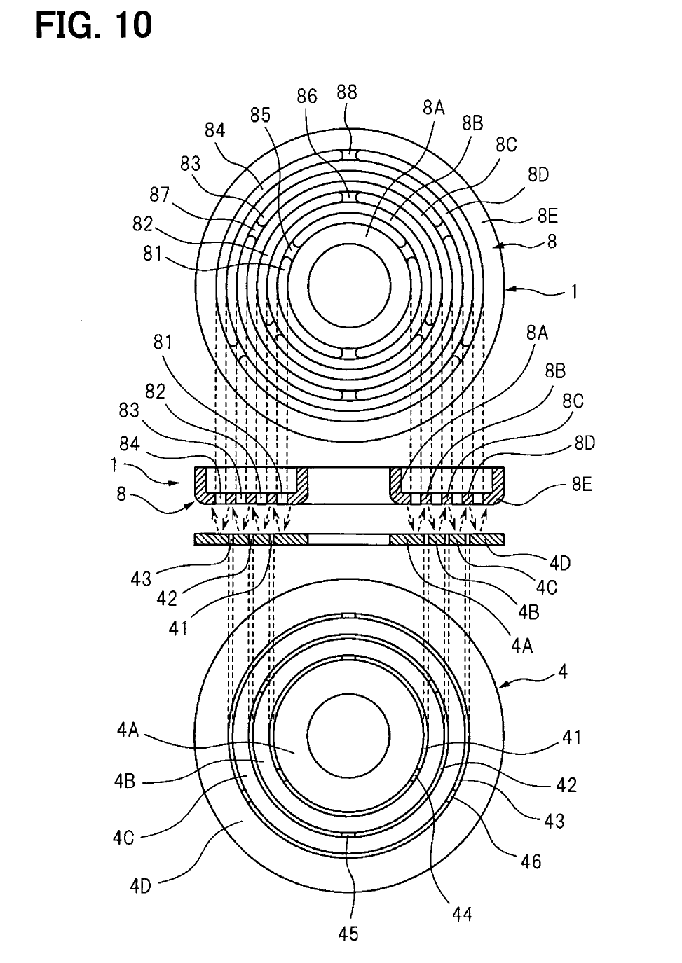

FIG. 10 illustrates a schematic configuration of the rotor 1 having four slits 81, 82, 83, and 84 and the armature 4 having three slits 41, 42, and 43 which are employed in the present disclosure. FIG. 10 illustrates the connection portions 44, 45, 46 disposed in the slits 41, 42, and 43 and the connection portions 85, 86, 87, and 88 disposed in the slits 81, 82, 83, and 64. When four slits 81, 82, 83, and 84 are disposed in the rotor 1, the connection portions 85, 86, 87, and 88 are disposed at three locations in each of the slits 81, 82, 83, and 84. In the example, the connection portions 85, 86, 87, and 88 are disposed at every 120 degrees around the rotor 1. However, the number and the position of the connection portions 85, 86, 87, and 88 are not limited to the example. The slits 81, 82, 83, and 84 split the friction plate 8 into the first rotor portion 8A, the second rotor portion 8B, the third rotor portion 8C, the fourth rotor portion 8D, and the fifth rotor portion 8E sequentially from the inner side.

When four slits 81, 82, 83, and 84 are disposed in the rotor 1, the slits 41, 42, and 43 are respectively disposed in portions opposing the second rotor portion 8B, the third rotor portion 8C, and the fourth rotor portion 8D in the opposing armature 4. Accordingly, the radii of the slits 41, 42, and 43 have values different from the radii of the slits 81, 82, 83, and 84. When three slits 41, 42, and 43 are disposed in the armature 4, the connection portions 44, 45, and 46 are disposed at three locations in each of the slits 41, 42, and 43. In the example, the connection portions 44, 45, and 46 are disposed at every 120 degrees around the armature 4. However, the number and the position of the connection portions 44, 45, and 46 are not limited to the example. The slits 41, 42, and 43 split the armature 4 into the first ring portion 4A, the second ring portion 4B, the third ring portion 4C, and the fourth ring portion 4D sequentially from the inner side.

The first ring portion 4A opposes the first and second rotor portions 8A and 8B, the second ring portion 4B opposes the second and third rotor portions 8B and 8C, the third ring portion 4C opposes the third and fourth rotor portions 8C and 8D, and the fourth ring portion 4D opposes the fourth and fifth rotor portions 8D and 8E. In this manner, a set of opposing surfaces through which the magnetic flux passes, that is, eight opposing magnetic paths are present between the armature 4 and the friction plate 8 of the rotor 1. In the configuration, the magnetic flux flowing out from the first rotor portion 8A is interlinked with eight opposing magnetic paths in a route sequentially from the first ring portion 4A, to the second rotor portion 8B, the second ring portion 4B, the third rotor portion 8C, the third ring portion 4C, the fourth rotor portion 8D, the fourth ring portion 4D, and to the fifth rotor portion 8E as illustrated by the dashed line in FIG. 10.

In a case where eight opposing magnetic paths are present between the rotor 1 and the armature 4, the attraction force and the magnetomotive force in an on state of the electromagnetic clutch, and the attraction force and the magnetomotive force acting when the electromagnetic clutch is switched from an off state to an on state show a characteristic of degraded operability similarly to a case where six opposing magnetic paths are present therebetween. Accordingly, in a case where eight opposing magnetic paths are present between the rotor 1 and the armature 4, similarly to a case where four opposing magnetic paths are present between the rotor 1 and the armature 4, it is also possible to perform the control by changing the magnetomotive force using the magnetomotive force change circuit 10 such as the DC-DC converter 11 and the PWM control circuit 12 according to the present disclosure.

In the above-described embodiments, the electromagnetic clutch 100 is applied to the compressor of the vehicle air conditioner. However, the electromagnetic clutch according to the present disclosure can also be similarly applied to other rotating machines. Therefore, the rotor 1 may be driven by other rotary drive sources (for example, a motor) instead of driving the rotor 1 by using power transmitted from the engine. In addition, driven-side machines to which a rotation force is transmitted via the electromagnetic clutch 100 may be machines other than a compressor.

The above-described configurations are merely examples. As long as the examples do not impair the features of the present disclosure, the present disclosure is not limited by the above-described embodiments and modified examples. The configuration elements in the above-described embodiments and modified examples include those which are replaceable and are obviously used as a substitute therefor while maintaining identity of the disclosure. That is, other forms considered to be included within the scope of the technical idea according to the present disclosure are included within the scope of the present disclosure. As described above, according to the electromagnetic clutch, the electromagnetic clutch control device, and the electromagnetic clutch control method, when a command to start power supply to the electromagnetic coil of the electromagnetic clutch is issued, a stronger than usual magnetomotive force is applied to the electromagnetic coil. Therefore, when the command to start power supply to the electromagnetic coil is issued, a strong electromagnetic attraction force is generated between the rotor and the armature. Accordingly, operability of the electromagnetic clutch can be improved when the electromagnetic clutch is switched from an off state to an on state. If the armature is magnetically attracted to the friction plate thereafter, the magnetomotive force of the electromagnetic coil returns to the normal state magnetomotive force. Therefore, power consumption of the electromagnetic coil can be minimized.

What is claimed is:

1. An electromagnetic clutch comprising:
an armature that is attached to a rotary shaft;
at least two non-magnetic portions that are disposed in the armature, the at least two non-magnetic portions having varying radii;
a rotor that is rotated with respect to the rotary shaft by an external force;
a friction plate that faces the armature and is included in the rotor;
at least three non-magnetic portions that are disposed in the friction plate and do not overlap the at least two non-magnetic portions, the at least three non-magnetic portions having varying radii;
a stator;
an electromagnetic coil that is included in the stator, the electromagnetic coil generating, when a power is supplied to the electromagnetic coil, a magnetic flux that is applied to the friction plate and causing the armature to be magnetically attracted to and fixedly attached to the rotor;
a control device that controls supplying power to the electromagnetic coil; and
a magnetomotive force change unit that is included in the control device, wherein
when a command to start supplying power to the electromagnetic coil is issued, the magnetomotive force change unit increases a magnetomotive force of the electromagnetic coil, and
when the armature is magnetically attracted to and fixedly attached to the rotor, the magnetomotive force change unit returns the magnetomotive force of the electromagnetic coil to a normal operation magnetomotive force.

2. The electromagnetic clutch according to claim 1, wherein
the at least two non-magnetic portions are two non-magnetic portions, and the at least three non-magnetic portions are three non-magnetic portions.

3. The electromagnetic clutch according to claim 2, wherein
the two non-magnetic portions are two slits and the three non-magnetic portions are three slits,
the two slits split the armature, sequentially from a side of the rotary shaft, into a first ring portion, a second ring portion, and a third ring portion,
the first ring portion and the second ring portion are connected to each other, and the second ring portion and the third ring portion are connected to each other, by connection portions that divide the two slits into multiple portions in a circumferential direction,
the three slits split the rotor, sequentially from the side of the rotary shaft, into a first rotor portion, a second rotor portion, a third rotor portion, and a fourth rotor portion, and
the first rotor portion and the second rotor portion are connected to each other, the second rotor portion and the third rotor portion are connected to each other, and the third rotor portion and the fourth rotor portion are connected to each other, by connection portions that divide the three slits into multiple portions in the circumferential direction.

4. The electromagnetic clutch according to claim 2, wherein
the two non-magnetic portions are two non-magnetic rings and the three non-magnetic portions are three non-magnetic rings,
the two non-magnetic rings split the armature, sequentially from a side of the rotary shaft, into a first ring portion, a second ring portion, and a third ring portion,
the two non-magnetic rings connect the first ring portion and the second ring portion to each other, and connect the second ring portion, and the third ring portion to each other,
the three non-magnetic rings split the rotor, sequentially from the side of the rotary shaft, into a first rotor portion, a second rotor portion a third rotor portion, and a fourth rotor portion, and
the three non-magnetic rings connect the first rotor portion and the second rotor portion to each other, connect the second rotor portion and the third rotor portion to each other, and connect the third rotor portion and the fourth rotor portion to each other.

5. The electromagnetic clutch according to claim 1, wherein
the rotor includes a recess, which is ring shaped, on a rear surface of the friction plate, and
the electromagnetic coil of the stator is arranged inside the recess.

6. The electromagnetic clutch according to claim 1, wherein
the magnetomotive force change unit determines, based on an elapsed time from when the command to start supplying power to the electromagnetic coil is issued, a time when the armature is magnetically attracted to and fixedly attached to the rotor.

7. The electromagnetic clutch according to claim 1, wherein
the magnetomotive force change unit includes a voltage change unit,
when the command to start supplying power to the electromagnetic coil is issued, the voltage change unit increases a voltage applied to the electromagnetic coil to be higher than a normal voltage, the normal voltage being applied to the electromagnetic coil during a normal operation of the electromagnetic clutch, and
when the armature is magnetically attracted to and fixedly attached to the rotor, the voltage change unit returns the voltage applied to the electromagnetic coil to the normal voltage.

8. The electromagnetic clutch according to claim 1, wherein
the magnetomotive force change unit includes a duty ratio change unit,
when the command to start supplying power to the electromagnetic coil is issued, the duty ratio change unit increases a duty ratio of a current supplied to the electromagnetic coil to be higher than a normal duty ratio, the normal duty ratio being used during a normal operation of the electromagnetic clutch, and
when the armature is magnetically attracted to and fixedly attached to the rotor, the duty ratio change unit returns the duty ratio of the current supplied to the electromagnetic coil to the normal duty ratio.

9. An electromagnetic clutch control device for an electromagnetic clutch, the electromagnetic clutch including
an armature that is attached to a rotary shaft,
at least two non-magnetic portions that are disposed in the armature, the at least two non-magnetic portions having varying radii,
a rotor that is rotated with respect to the rotary shaft by an external force,
a friction plate that faces the armature and is included in the rotor,
at least three non-magnetic portions that are disposed in the friction plate and do not overlap the at least two non-magnetic portions, the at least three non-magnetic portions having varying radii,
a stator, and
an electromagnetic coil that is included in the stator, the electromagnetic coil generating, when a power is supplied to the electromagnetic coil, a magnetic flux that is applied to the friction plate and causing the armature to be magnetically attracted to and fixedly attached to the rotor, the electromagnetic clutch control device comprising:
a magnetomotive force change unit, wherein
when a command to start supplying power to the electromagnetic coil is issued, the magnetomotive force change unit increases a magnetomotive force of the electromagnetic coil, and
when the armature is magnetically attracted to and fixedly attached to the rotor, the magnetomotive force change unit returns the magnetomotive force of the electromagnetic coil to a normal operation magnetomotive force.

10. The electromagnetic clutch control device according to claim 9, wherein
the magnetomotive force change unit determines, based on an elapsed time from when the command to start supplying power to the electromagnetic coil is issued, a time when the armature is magnetically attracted to and fixedly attached to the rotor.

11. The electromagnetic clutch control device according to claim 9, wherein
the magnetomotive force change unit, includes a voltage change unit, when the command to start supplying power to the electromagnetic coil is issued, the voltage change unit increases a voltage applied to the electromagnetic coil to be higher than a normal voltage, the normal voltage being applied to the electromagnetic coil during a normal operation of the electromagnetic clutch, and
when the armature is magnetically attracted to and fixedly attached to the rotor, the voltage change unit returns the voltage applied to the electromagnetic coil to the normal voltage.

12. The electromagnetic clutch control device according to claim 9, wherein
the magnetomotive force change unit includes a duty ratio change unit,
when the command to start supplying power to the electromagnetic coil is issued, the duty ratio change unit increases a duty ratio of a current supplied to the electromagnetic coil to be higher than a normal duty ratio, the normal duty ratio being used during a normal operation of the electromagnetic clutch, and
when the armature is magnetically attracted to and fixedly attached to the rotor, the duty ratio change unit returns the duty ratio of the current supplied to the electromagnetic coil to the normal duty ratio.

13. An electromagnetic clutch control method for controlling an electromagnetic clutch, the electromagnetic clutch including
an armature that is attached to a rotary shaft,
at least two non-magnetic portions that are disposed in the armature, the at least two non-magnetic portion having varying radii,
a rotor that is rotated with respect to the rotary shaft by an external force,
a friction plate that faces the armature and is included in the rotor,
at least three non-magnetic portions that are disposed in the friction plate and do not overlap the at least two non-magnetic portions, the at least three non-magnetic portions having varying radii,
a stator,
an electromagnetic coil that is included in the stator, the electromagnetic coil generating, when a power is supplied to the electromagnetic coil, a magnetic flux that is applied to the friction plate and causing the armature to be magnetically attracted to and fixedly attached to the rotor, and
a control device that controls supplying power to the electromagnetic coil, the electromagnetic clutch control method comprising:
when a command to start supplying power to the electromagnetic coil is issued, increasing, by the control device, a magnetomotive force of the electromagnetic coil; and
when the armature is magnetically attracted to and fixedly attached to the rotor, returning, by the control device, the magnetomotive force of the electromagnetic coil to a normal operation magnetomotive force.

14. The electromagnetic clutch control method according to claim 13, wherein
the control device determines, based on an elapsed time from when the command to start supplying power to the electromagnetic coil is issued, a time when the armature is magnetically attracted to and fixedly attached to the rotor.

15. The electromagnetic clutch control method according to claim 13, wherein
the control device includes a voltage change unit,
when the command to start supplying power to the electromagnetic coil is issued, the voltage change unit increases a voltage applied to the electromagnetic coil to be higher than a normal voltage, the normal voltage being applied to the electromagnetic coil during a normal operation of the electromagnetic clutch, and
when the armature is magnetically attracted to and fixedly attached to the rotor, the voltage change unit returns the voltage applied to the electromagnetic coil to the normal voltage.

16. The electromagnetic clutch control method according to claim 13, wherein
the control device includes a duty ratio change unit,
when the command to start supplying power to the electromagnetic coil is issued, the duty ratio change unit increases a duty ratio of a current supplied to the electromagnetic coil to be higher than a normal duty ratio, the normal duty ratio being used during a normal operation of the electromagnetic clutch, and
when the armature is magnetically attracted to and fixedly attached to the rotor, the duty ratio change unit returns the duty ratio of the current supplied to the electromagnetic coil to the normal duty ratio.
